(19) United States
(12) Patent Application Publication
(10) Pub. No.: US 2004/0260625 A1
(43) Pub. Date: Dec. 23, 2004

(54) Digital photo print order acceptance method and digital image management method

(76) Inventors: Yoshinori Usami, Minato-ku (JP); Toshiaki Kawase, Minato-ku (JP); Susumu Minami, Minato-ku (JP); Toshihiko Narita, Minato-ku (JP)

Correspondence Address: BIRCH STEWART KOLASCH & BIRCH, PO BOX 747, FALLS CHURCH, VA, 22040-0747, US

(21) Appl. No.: 10/868,797

(22) Filed: Jun. 17, 2004

(30) Foreign Application Priority Data
Jun. 20, 2003 (JP) 2003-176534
Jun. 20, 2003 (JP) 2003-176535

(51) Int. Cl. G06F 17/60

(52) U.S. Cl. 705/26

(57) ABSTRACT

It is a digital photo print order acceptance method of separating a presentation and print order acceptance from a work flow of a photo studio so as to reduce a burden on the photo studio and allow a user to place a print order at any desirable time while viewing images matching with finished images of photo-prints. Original images of the user digitally shot at the photo studio are uploaded on a network server as unprocessed view images of a smaller image size than the original images. If image processing for proper printing is performed to the original images at the photo studio, image processing information indicating the image processing is transferred to the network server as supplementary information to the view images. The network server performs the image processing to the uploaded unprocessed view images based on the image processing information supplementary to the view images, renders image-processed view images viewable on a user terminal and accepts the print orders.

### BACKGROUND OF THE INVENTION

1. Field of the Invention

The present invention relates to a digital photo print order acceptance method and a digital image management method, and in particular, to the digital photo print order acceptance method and digital image management method of the photos digitally shot at a photographer's studio or a shooting studio.

2. Description of the Related Art

As shown in FIG. 9, it has been usual so far that, if digital shooting is performed with a digital camera 12 of a photographer's studio 10, a presentation is made, immediately after finishing the shooting, for the sake of displaying images obtained by the digital shooting on a display 14 in the photographer's studio and having the images to be photo-printed selected by a user.

The photographer's studio 10 performs image processing such as color correction, gradation correction, trimming process and image composition (template composition) to digital images selected by the presentation with an image processing apparatus 16. It records the image-processed digital images as well as order information such as the number of prints and print size on a medium and sends it to a processing station 20.

The processing station 20 digitally prints the digital images received from the photographer's studio 10 with a digital printer 22 according to the order information of the user, and delivers these digitally printed photo-prints to the photographer's studio 10. There are also the cases where they are printed by a digital printer 18 in the photographer's studio 10 rather than the digital printer 22 of the processing station 20.

There has also been a proposal of a studio photography support system capable of checking a finished image of a photo before shooting (Japanese Patent Application Publication No. 2002-314993).

This system reads and displays the images of items such as a backdrop, a photography set and a costume for rent from a database on which the images of the backdrops, photography sets and costumes for rent necessary for taking studio photos are registered so as to have a selection made by the user as to each item. And it performs image composition of the images of the selected items such as the backdrop, photography set and costume for rent and a face image of the user recorded on a recording medium brought by the user or that taken by the digital camera of the studio so that the finished image of the studio photo can be checked before actual shooting and a reservation for the shooting can be made after checking unbooked dates and hours when the backdrop, photography set and costume for rent are available.

However, as for the digital shooting at the photo studio such as the photographer's studio or the shooting studio, a large number of photos are taken by changing poses, costumes and so on as to one user. Consequently, it takes a long time for the presentation made after the shooting, and so there is a problem that both the presenter on the photographer's studio side and user need to spare a lot of time. It is also a hard work for the user who is tired after the shooting to further select shooting frames. And the presentation cannot be made for those who are not present, and so there is a problem that a desired print is missed or trouble of reordering needs to be taken.

The digital images presented at the presentation made immediately after the digital shooting have undergone default image processing by an image processing function in the digital camera. However, they have not undergone various kinds of image processing such as corrections, modifications and trimming processes at the photographer's studio for the sake of creating proper photo prints. For that reason, there is a problem that the user cannot see the finished image of the photo-print in the presentation and must order the prints based on a presentation image not matching with the finished image.

In the presentation made immediately after the digital shooting, it is difficult to present the image matching with the finished image of the photo-print (that is, each digital image having undergone the image processing for the photo-print) due to temporal constraints and the large number of shot images.

In the system of Japanese Patent Application Publication No. 2002-314993, the finished image of the photo checkable before actual studio shooting is a composite picture having combined the images of the backdrop, photography set and costume for rent prepared in advance and a facial portrait of the user, and is not an original image obtained in the actual shooting and then having undergone various kinds of image processing.

Furthermore, as for the image data after the shooting, there is a problem that it is a heavy load for facilities and management of the photo studio to back up the image data on all the original images obtained in the shooting for a long period of time for the sake of accepting photo-print orders. On the other hand, if the image data on the original images is recorded on a recording medium such as a CD-R and is handed to the user, there is a possibility that there may be no reorder from the user.

There has also been a proposal of a digital content distribution system which encodes the digital contents such as images and music and records them on a CD-ROM and so on to distribute it to the user for free, and if the user wants to reproduce the digital contents, it sends user identification data for electronic settlement to a digital content provider and receives a decoding key for decoding the digital contents from digital content provider (Japanese Patent Application Publication No. 2002-334172). The digital content distribution system described in Japanese Patent Application Publication No. 2002-334172 is not the system for backing up the image data on the original images of each user taken at the photo studio.

### SUMMARY OF THE INVENTION

An object of the present invention is to provide a digital photo print order acceptance method capable of reducing a burden on a photo studio such as a photographer's studio or a shooting studio by omitting a presentation made immediately after digital shooting and promoting acceptance of print orders as with execution of the presentation, allowing a user to carefully select images for a print order and by taking time at any desirable time and place the print order by seeing the images matching with finished images of photo prints so as to thereby receive the photo-prints in accordance with the images of the print order.

Another object of the present invention is to provide a digital image management method and print order acceptance method capable of storing and managing a large amount of digital images of each user digitally shot at the photo studio without a burden on the photo studio and also handling a reorder for the photo prints well.

The present invention is the digital photo print order acceptance method for having the digital images digitally shot at the photo studio viewed by the user, printing the digital images for which the print order has been accepted from the user and providing them to the user, wherein the method includes steps of: uploading on a network server unprocessed view images of a smaller image size than original images obtained by the digital shooting from a terminal of the photo studio; performing image processing for proper printing to the original images at the photo studio; uploading on the network server image processing information indicating the image processing corresponding to the view images uploaded on the network server as supplementary information to the view information; performing image processing to the view images uploaded on the network server based on the image processing information supplementary to the view images, and rendering image-processed view images viewable on the terminal of the user; and if the print order is placed based on the view images by using the terminal of the user, posting the order information indicating the print order to the terminal of the photo studio.

To be more specific, it uploads on the network server the unprocessed view images of a smaller size than the original images generated from the original images instead of the presentation made immediately after the digital shooting. And if the photo studio performs the image processing to the original images for the sake of proper printing (a color correction, a gradation correction, a trimming process, a red-eye process and so on), it uploads the image processing information indicating the image processing as supplementary information to the view image simultaneously or separately on the network server.

The network server performs the image processing to the uploaded unprocessed view images based on the image processing information supplementary to the view images, and renders the image-processed view images viewable on the terminal of the user. As the unprocessed view images and the image processing information supplementary to the view images are uploaded on the network server, the unprocessed view images can be uploaded immediately after the shooting, and the image processing information can be transferred to the network server at an appropriate time after uploading the unprocessed view images. It is also possible to update only the image processing information as required. And the user can carefully select the images for the print order at home at any time while checking processed finished images on the network server. It is further possible to perform the trimming, check the images simulating end items such as a finish of an album and select and specify a processing method.

If the print order is placed based on the view images by using the terminal of the user, the order information indicating the print order is posted to the terminal of the photo studio via the network server.

The present invention is the digital photo print order acceptance method wherein the image processing information supplementary to the view images uploaded on the network server is utilized for calculation of a usage fee of an image processing device which performs the image processing for properly printing the original images conducted at the photo studio.

A provider who provides the image processing device which performs the image processing for proper printing to the photo studio can obtain the number of times of use of the image processing device from the image processing information supplementary to the view images uploaded on the network server. Therefore, it is possible to charge the usage fee according to the number of times of use of the image processing device.

Furthermore, the present invention is the digital photo print order acceptance method wherein the photo studio sends the original images for the order information, the image processing information and the order information to a processing station via a network or a recording medium.

The present invention is the digital photo print order acceptance method wherein it detects the image processing information sent to the processing station based on the image processing information supplementary to the view images uploaded on the network server and the order information from the terminal of the user, and utilizes the detected image processing information for calculation of the usage fee of the image processing device which performs the image processing for the proper printing to the original images used by the processing station.

A provider who provides the image processing device which performs the image processing for proper printing to the processing station (laboratory) can detect the number of times of use of the image processing device based on the image processing information supplementary to the view images uploaded on the network server and the order information from the terminal of the user. Therefore, it is possible to charge the usage fee according to the number of times of use of the image processing device.

Another form of the present invention is the digital photo print order acceptance method for having the digital images digitally shot at the photo studio viewed by the user, printing only the digital images for which the print order has been accepted from the user and providing them to the user, wherein the method includes the steps of: uploading on the network server the view images of a smaller image size than the original images obtained from the terminal of the photo studio by the digital shooting and having undergone no image processing for printing from the terminal of the photo studio; rendering the view images uploaded on the network server viewable on the terminal of the user, and if the user selects the image of which print finish check is desired out of the view images, posting the information on the selected images to the terminal of the photo studio; performing the image processing for the proper printing to the original images corresponding to the selected images at the photo studio; rendering the view images for checking the print finish to which the image processing has been performed viewable to the user via the network server and the terminal of the user; and if the print order is placed based on the view images for checking the print finish by using the terminal of the user, posting the order information indicating the print order to the terminal of the photo studio.

To be more specific, it has the unprocessed view images uploaded on the network server from the terminal of the photo studio after the digital shooting viewed by the user so as to have the desired images for checking the print finish selected by the user. The information on the selected images is posted to the terminal of the photo studio from the terminal of the user via the network server.

On receiving the information on the images selected by the user, the photo studio performs the image processing for the proper printing only to the selected images out of the original images of the user, and renders the view images for checking the print finish to which the same image processing as this has been performed viewable to the user via the network server and the terminal of the user. It is also possible, as to the selected images, to select an album frame, an album layout and so on prepared in advance so as to check an end item image.

Thus, the photo studio has only to perform the image processing for the proper printing to the images selected by the user (images highly likely to be print-ordered) out of a large number of original images taken by changing poses, costumes and so on as to one user. Therefore, it is possible to reduce the burden on the photo studio.

If the print order is placed from the terminal of the user based on the view images for checking the print finish, the order information indicating the print order is posted to the terminal of the photo studio via the network server. Thus, the user can check the images matching with the finished images of the photo-prints before placing the print order.

A further form of the present invention is the digital photo print order acceptance method wherein it includes the steps of: encoding the image data on the original images obtained by the digital shooting at the photo studio by using a key of cryptograph and recording it on a removable recording medium to be provided to the user; creating preview images of a smaller image size than the original images from the original images and recording the image data on the preview images on the recording medium; associating identification data on the user possessing the recording medium with the key of cryptograph used to encode the original images on the recording medium and managing them in a database; accepting the print order for desired original images recorded on the recording medium from the user possessing the recording medium; taking the key of cryptograph used to encode the image data on the original images on the recording medium from the database based on the identification data on the user possessing the recording medium; and decoding the image data on the print-ordered original images recorded on the recording medium by using the key of cryptograph taken out.

To be more specific, the image data on the original images obtained by the digital shooting at the photo studio is encoded by using the key of cryptograph, and is recorded on the removable recording medium provided to the user. The recording medium further has the preview images of a smaller image size than the original images recorded thereon, and is handed to the user. Therefore, the image data on the original images is stored and managed by the user. The user can view the preview images recorded on the recording medium by using a personal computer and so on. However, the encoded image data on the original images cannot be exploited.

The photo studio associates the identification data on the user possessing the recording medium with the key of cryptograph used to encode the original images on the recording medium and manages them in a database. Therefore, the photo studio can decode the encoded image data on the original images recorded on the recording medium brought by the user by using the key of cryptograph managed in the database to exploit it.

As previously described, the user can view the preview images recorded on the recording medium by using the personal computer and so on at home, it is possible to place the order for new photo-prints in addition to the order for extra prints of the photos. And if there are the images to be printed, the user brings the recording medium to the photo studio and places the print order. The print order can also be placed on the network.

The photo studio takes the key of cryptograph unique to the user from the database based on the identification data on the user possessing the recording medium, and decodes the image data on the print-ordered original images recorded on the recording medium by using the key of cryptograph. The image data on the original images thus decoded is exploited for the photo-printing.

The present invention is also the digital photo print order acceptance method wherein it has the steps of: performing the image processing for proper printing to the image data on the print-ordered original images; and registering image processing information indicating the contents of the image processing with the database by associating it with the identification data on the user and a file name of the original images.

To be more specific, the photo studio performs the image processing such as the trimming, color correction and retouch to the print-ordered original images, and registers the image processing information indicating the contents of this image processing with the database by associating it with the identification data on the user and the file name of the original images. Thus, it is possible, in the case of accepting the order for extra prints of the photos, to have the same finish of the photo-prints by using the image processing information registered with the database. The image processing information reflects shooting conditions and processing conditions of each photo studio, the user's preferences and so on, and the user having ordered the photo-prints can receive finished prints including these effects as many times as desired.

Furthermore, the present invention is the digital photo print order acceptance method wherein it sends to the processing station the image data on the original images, the image processing information indicating the contents of the image processing for the image data on the original images, and the order information indicating the contents of the print order. It is possible to send to the processing station either the recording medium having the image data on the original images and so on recorded thereon or the image data on the original images and so on via the network. It is possible to perform the image processing based on the image processing information at the processing station and send the processed images and the order information to the processing station.

The digital image management method in another form of the present invention is the one wherein it includes the steps of: encoding the image data on the original images obtained by the digital shooting at the photo studio by using the key of cryptograph and recording it on the removable recording medium to be provided to the user; creating the preview images of a smaller image size than the original images from the original images and recording the image data on the preview images on the recording medium; and associating the identification data on the user possessing the recording medium with the key of cryptograph used to encode the original images on the recording medium and managing them in the database.

The present invention is also the digital image management method wherein it records the identification data on the user possessing the recording medium on the recording medium. It is thereby possible to easily take out the key of cryptograph of the user managed in the database.

Furthermore, the present invention is also the digital image management method wherein it records on the recording medium a viewer software program for viewing the preview images recorded on the recording medium. Thus, the user can view the preview images just by setting the recording medium on the personal computer without preparing a special viewer software program on his or her part. The present invention is also the digital image management method wherein the recording medium is a CD, a DVD or a memory card.

### BRIEF DESCRIPTION OF THE DRAWINGS

The exact nature of this invention, as well as other objects and advantages thereof, will be readily apparent from consideration of the following specification relating to the accompanying drawings, in which like reference characters designate the same or similar parts throughout the figures thereof and wherein:

FIG. 1 is a configuration diagram of a system to which a digital photo print order acceptance method according to the present invention is applied;

FIG. 2 is a flowchart used for describing a flow from digital shooting at a photo studio to print order acceptance on a network;

FIG. 3 is a diagram showing a work flow indicating a management method and a print order acceptance method of digital images according to the present invention;

FIG. 4 is a block diagram showing an example of a hardware configuration of an image processing apparatus;

FIG. 5 is a block diagram showing an example of the hardware configuration of an information management apparatus;

FIG. 6 is an image diagram of data to be recorded on a CD-R;

FIG. 7 is a diagram showing a scramble key database;

FIG. 8 is a diagram showing an image processing information database; and

FIG. 9 is a diagram showing a work flow of a photographer's studio including a presentation for accepting a print order in the past.

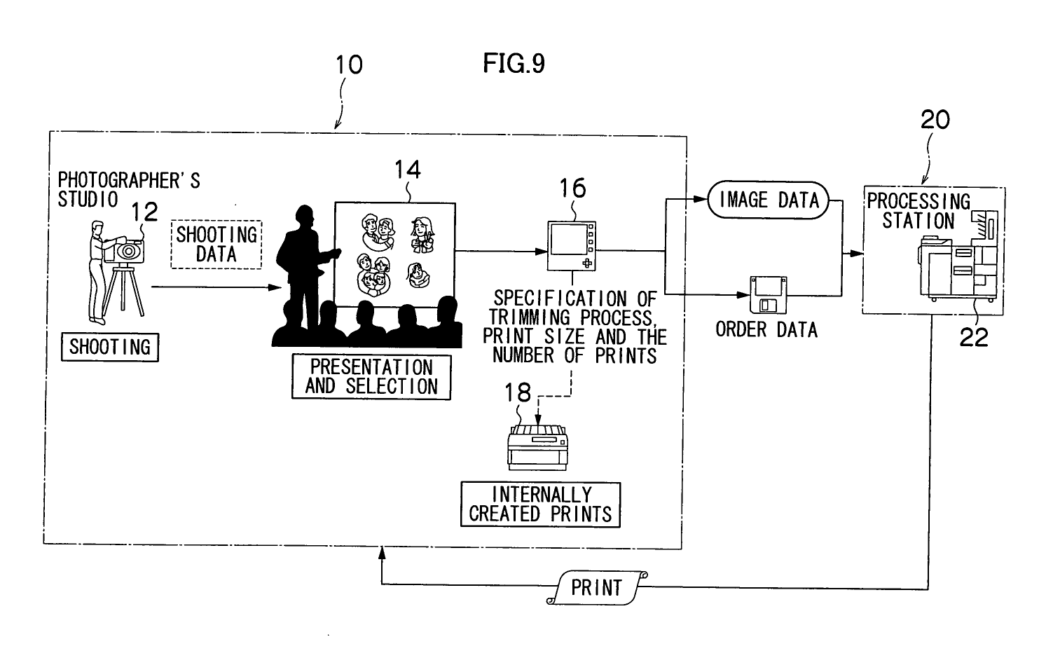

### DETAILED DESCRIPTION OF THE PREFERRED EMBODIMENTS

Detailed description will hereunder be given of the preferred embodiment of DIGITAL PHOTO PRINT ORDER ACCEPTANCE METHOD AND DIGITAL IMAGE MANAGEMENT METHOD according to the present invention with reference to the accompanying drawings.

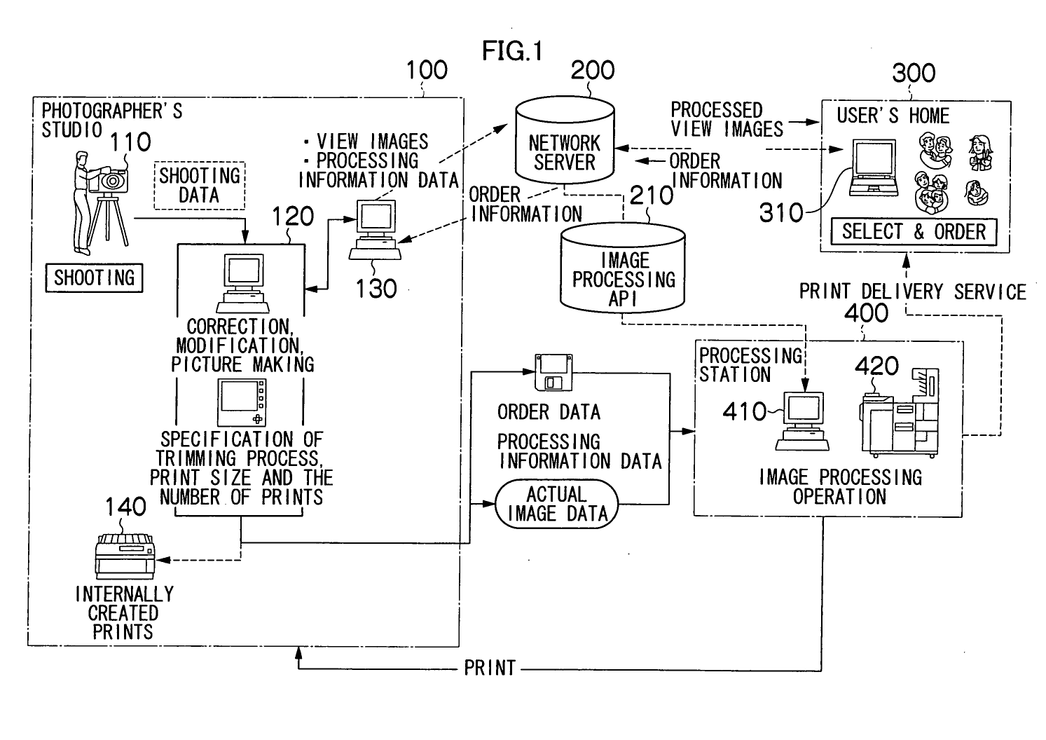

FIG. 1 is a configuration diagram of a system to which a digital photo print order acceptance method according to the present invention is applied.

In FIG. 1, reference numeral 100 designates a photographer's studio, 200 designates a network server, 300 designates a user's home, and 400 designates a processing station for creating photo-prints.

The photographer's studio 100 has a digital camera 110 for digitally shooting the user, an image processing apparatus 120, a terminal 130 such as a personal computer (hereafter, referred to as a client terminal) and a digital printer 140 provided therein.

A photographer of the photographer's studio 100 operates the digital camera 110, and usually takes several tens of photos for one user by changing poses, costumes and so on. Digital images (original images) thus digitally shot are stored in a large-capacity medium such as a hard disk of the image processing apparatus 120 via a medium of the digital camera 110 or via a communication cable such as a USB cable.

The image processing apparatus 120 comprises an image processing device (including image processing software) which performs the image processing for proper printing to the original images and an operation device which specifies a trimming process, a print size, the number of prints and so on. An operator can operate the image processing apparatus 120 to perform a color correction, a gradation correction, the trimming process, an image composition (template composition), a red-eye process and so on to the original images.

The image processing apparatus 120 and the client terminal 130 are capable of mutual communication. The image processing apparatus 120 sends the original images and information on the image processing performed to the original images on the image processing apparatus 120 (image processing information) to the client terminal 130. And the client terminal 130 sends the information on the desired images for checking the print finish selected by the user and print order information to the image processing apparatus 120. On receiving the print order information, the image processing apparatus 120 records image data on the original images corresponding to the print order (raw data as is in a color filter arrangement of R, G and B of an image-taking element of the digital camera 110, for instance), information on the image processing performed to the original images, and the order information on a recording medium. This recording medium is sent to the processing station 400 in order to request creation of photo-prints.

The image processing information may be either included in an image file of the original images or separately stored in a database managed by the photographer's studio 100 so as to post an address for reading corresponding image processing information from the database. Furthermore, it is also possible to transfer the image data on the original images and so on from the photographer's studio 100 to the processing station 400 via a network.

It is also possible, instead of requesting the processing station 400 to create the photo-prints, to send the image-processed image data on the original images for which print order has been accepted from the image processing apparatus 120 to the digital printer 140 in the photographer's studio 100 so as to create the photo-prints thereon.

The client terminal 130 resizes the original images received from the image processing apparatus 120 to images of a smaller image size than original images, and uploads the resized images as view images to the network server 200. The image size of the view images is vertically long such as 320×480 pixels (a portrait photo is usually vertically long because it is often vertically shot) for instance. The resizing process for creating the view images from the original images may be performed on the image processing apparatus 120.

The client terminal 130 sends the image processing information received from the image processing apparatus 120 to the network server 200 together with supplementary information for associating it with the view images to which the image processing should be performed (a file name, for instance).

The network server 200 comprises an image processing device 210 which image-processes unprocessed view images with the image processing information supplementary to the view images and emulates finished images of the photo-prints (processed view images) on the network, a view image registration function, a function of having the registered view images viewed by the user, a user authentication function, a print order acceptance function and so on.

At a user's home 300, a terminal (hereafter, referred to as a “user terminal”) 310 such as a personal computer is provided. The user terminal 310 can use the network, and has a home page viewing function which is provided to an ordinary personal computer.

The user accesses the network server 200 on the network with the user terminal 310 by using a URL (Uniform Resource Locator) and further logs in by inputting a user ID and a password to view his or her view images uploaded on the network server 200 by the photographer's studio 100. The user can also select desired images and processing forms by using a print order screen provided by the network server 200 while viewing the view images so as to place the print order.

If the view images of each user are uploaded from the photographer's studio 100, the network server 200 issues the user ID and password to each user, and notifies each user of the URL, user ID and password of the network server 200 by e-mail or via the photographer's studio 100.

The processing station 400 has an image processing apparatus 410 and a digital printer 420 installed therein. The image processing apparatus 410 performs the image processing of the image data on the original images based on the image data on the original images received from the photographer's studio 100 via a digital medium and the information on the image processing performed to the original images, and sends to the digital printer 420 the image-processed image data and the information such as the print size and the number of prints. The image processing information used for the original images on the image processing apparatus 410 may be captured from the network server 200.

The digital printer 420 prints an image by performing scan exposure on silver salt color paper with an RGB laser based on the image-processed image data inputted from the image processing apparatus 410.

The photo-print created by the processing station 400 is delivered to the photographer's studio 100 having requested the print creation or directly delivered to the user's home 300 via a parcel delivery service.

Next, a flow from the digital shooting to the print order acceptance at the photographer's studio 100 will be described.

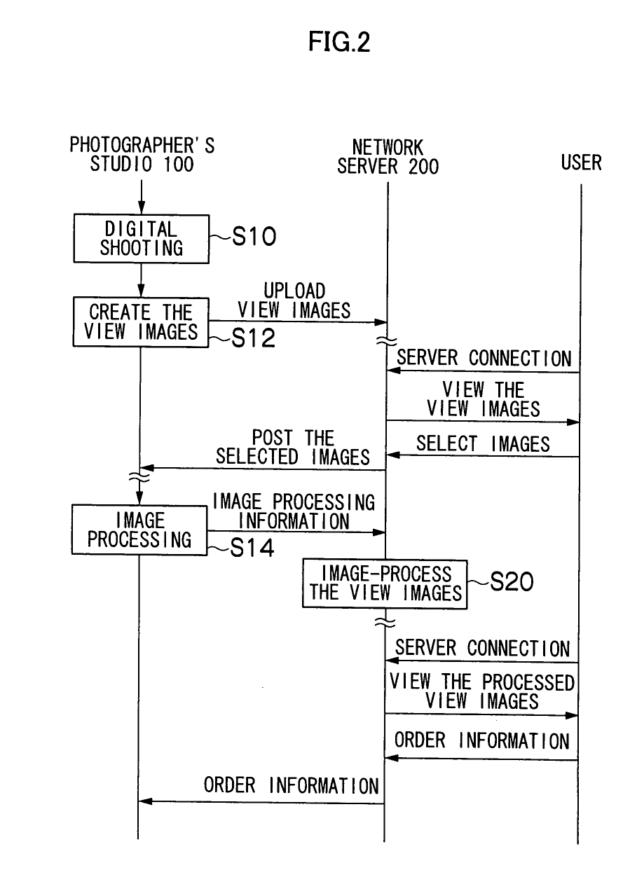

As shown in FIG. 2, the user is shot by the digital camera 110 at the photographer's studio 100 (step S10). If the digital shooting is finished, the view images of a small size are created from the original images (step S12), which are then uploaded on the network server 200.

After finishing the shooting at the photographer's studio 100, the user can access the network server 200 at home at any time and view his or her view images uploaded on the network server 200 by inputting the user ID and password. The view images at this point in time are the unprocessed images having undergone no image processing.

There are selection items of the desired images for checking the print finish out of the view images on the screen of the user terminal 310 on which the view images are displayed. And if the user selects the desired images for checking the print finish out of the view images, the information on the selected images (the user ID, file name and so on) is posted to the client terminal 130 of the photographer's studio 100 via the network server 200. It is also possible, at this point in time, to accept the print order such as the images to be printed and the number of prints.

When the photographer's studio 100 is notified of the selected desired images for checking the print finish via the network server 200, the operator of the photographer's studio 100 operates the image processing apparatus 120 only for the images selected by the user out of a series of the images of the user so as to perform the image processing (the color correction, gradation correction, trimming process, image composition (template composition), red-eye process and so on) for the proper printing to the selected images (original images) (step S14).

If the image processing is performed to the images selected by the user as described above, the image processing information indicating a kind, the contents and so on of the image processing is sent to the network server 200 via the client terminal 130 together with supplementary information for associating it with the view images to which the image processing should be performed.

On receiving the image processing information on the unprocessed view images from the photographer's studio 100, the network server 200 performs the image processing to the unprocessed view images based on the image processing information (step S20). Thereafter, if a server connection is made by the user again, it is possible to have the finished images of the photo-prints of the images selected in advance (processed view images) viewed by the user. In this case, the processed view images and the unprocessed view images are mixed, and so it is preferable to display the identification data or display the unprocessed view images and the processed view images side by side so that the user can distinguish them.

And if the print order is placed by indicating the selection of the images to be print-ordered and the number of prints on the screen of the user terminal 310 while checking the finished images of the photo-prints with the processed view images on the network, the order information indicating the print order is posted to the client terminal 130 of the photographer's studio 100 via the network server 200.

On thus receiving the order information, the photographer's studio 100 sends the image data, image processing information and order information on the print-ordered original images to the processing station 400 via the digital medium as previously described.

According to this embodiment, the image data and image processing information on the original images are sent to the processing station when requesting the processing station to create the photo-prints. It is also possible, however, to send to the processing station the image data on the original images having been image-processed as required by the image processing apparatus in the photographer's studio.

A provider who provides to the photo studio the image processing device which performs the image processing for the proper printing to the original images can detect the number of times of use of each image processing device based on the image processing information supplementary to the view images uploaded on the network server so that it is possible to charge a usage fee according to the number of times of use. It is also possible to provide a device which calculates the usage fee in the network server or send the information necessary to calculate the usage fee to the terminal of the provider who provides the image processing device from the network server so as to calculate the usage fee on the terminal of the provider.

Likewise, the provider who provides to the photo studio the image processing device which performs the image processing for the proper printing to the original images can detect the image processing information sent to the processing station based on the image processing information supplementary to the view images uploaded on the network server and the order information from the user terminal. And it is possible, based on the detected image processing information, to detect the number of times of use of each image processing device and charge the usage fee according to the number of times of use.

According to the present invention, the images of the user digitally shot at the photo studio such as the photographer's studio or the shooting studio are viewed by the user on the network, and the print order including the selection of the images to be print-ordered is accepted. Therefore, it is possible, as advantages of the present invention, to separate the presentation for accepting the print orders made immediately after the shooting at the photo studio from a work flow of the photo studio so as to reduce a burden on the photo studio and allow the user to carefully select the images for the print order taking time at any desirable time.

It has the unprocessed view images uploaded on the network server after the shooting viewed by the user to select the desired images for checking the print finish. And the photo studio performs the image processing for the properly printing the original images only to the images selected by the user so that the user can view the view images for checking the print finish having undergone the same image processing as this on the network. Therefore, it is not necessary to perform the image processing for printing to all the images taken by changing poses, costumes and so on as to one user so that the burden on the photo studio can be reduced, the user can view the view images matching with finished images of the photo prints as to the desired images for checking the print finish and thereby receive the photo-prints in accordance with the print-ordered images.

Furthermore, the photo studio transfers to the network server the image processing information indicating the image processing for properly printing the original images as the information supplementary to the unprocessed view images so that the view images are processed on the network server based on the image processing information. Therefore, there are the advantages that the unprocessed view images can be uploaded immediately after the shooting, the image processing information can be transferred to the network server at an appropriate time after uploading the unprocessed view images, and only the image processing information can be updated as required.

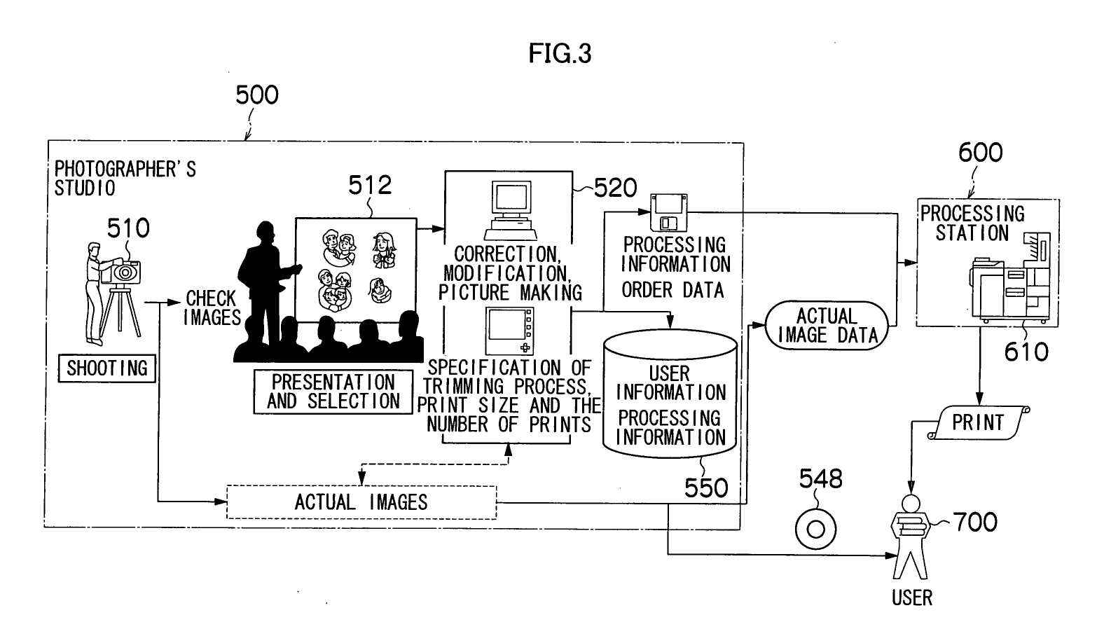

FIG. 3 is a diagram showing a work flow indicating the management method of the digital images and the print order acceptance method according to another embodiment of the present invention.

As shown in FIG. 3, a photographer's studio 500 has a digital camera 510 for digitally shooting the user, an image processing apparatus 520, and an information management apparatus 550 provided therein.

The photographer of the photographer's studio 500 operates the digital camera 510, and usually takes several tens of photos for one user by changing the poses, costumes and so on. The presentation is made by using the digital images thus digitally shot. To be more specific, the digital images digitally shot are displayed in order on a display 512 in the photographer's studio so as to have the images to be photo-printed selected by the user. It is also possible to upload the images to be photo-printed on a Web server and have them selected by the user by using a Web browser.

The digital images (original images) digitally shot are stored in a hard disk drive of the image processing apparatus 520 via a medium of the digital camera 510 or the communication cable such as the USB cable.

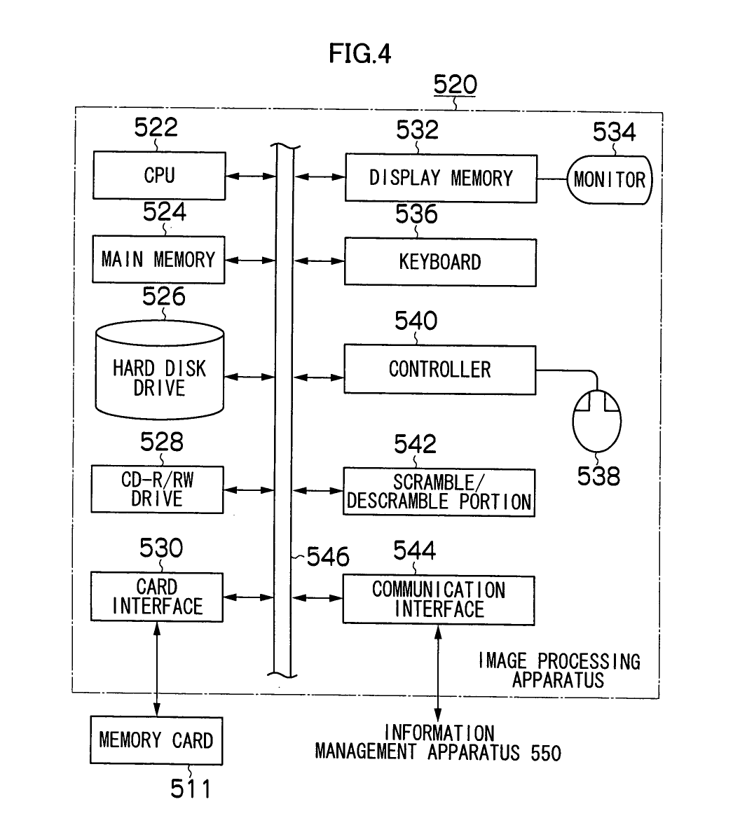

FIG. 4 is a block diagram showing an example of a hardware configuration of the image processing apparatus 520.

As shown in FIG. 4, the image processing apparatus 520 is mainly comprised of a central processing unit (CPU) 522 for controlling operations of components, a main memory 524 for storing a control program of the apparatus and becoming a work area on executing a program, an operating system (OS), a device driver of peripherals, image processing software for performing the image processing to properly print the original images, a hard disk drive 526 for storing the images of the user and so on, a CD-R/RW drive 528, a card interface 530 having a card insertion slot for mounting and removing a memory card 511, a display memory 532 for temporarily storing data for display, a monitor apparatus 534 such as a CRT monitor or a liquid crystal monitor for displaying the images, characters and so on with the image data, character data and so on from the display memory 532, a keyboard 536, a mouse 538 as a position inputting apparatus, a mouse controller 540 for detecting a state of the mouse 538 and outputting signals of a mouse pointer position on the monitor apparatus 534 and the state of the mouse 538 to the CPU 522, a scramble/descramble portion 542, a communication interface 544 and a bus 546 for connecting the components.

When the print order is accepted by the presentation and the original images are completely captured by the image processing apparatus 520 from the memory card 511 via the card interface 530, the operator operates the image processing apparatus 520 while watching the images for processing displayed on the monitor apparatus 534, and performs the image processing (color correction, gradation correction, trimming process, red-eye process, beautiful skin process and so on) for the sake of properly printing the original images for which the print order has been accepted.

Thereafter, the photographer's studio 100 records the image data on the original images for which the print order has been accepted, the information on the image processing (image processing information) performed to the original images in the image processing apparatus 520, and the order information such as the print size and the number of prints on the removable recording medium, and sends them to a processing station 600 which is a customer. It is also possible to send the image data on the original images and so on to the processing station 600 via the network. It is also possible, instead of requesting the processing station 600 to create the photo-prints, to send the image data on the original images after the image processing for which the print order has been accepted to the printer (not shown) in the photographer's studio 500 so as to create the photo-prints there.

The processing station 600 has an image processing apparatus and a digital mini-laboratory apparatus 610 which are not shown installed therein, where the image processing apparatus image-processes the image data on the original images based on the image data on the original images received from the photographer's studio 500 via the recording medium and the information on the image processing performed to the original images, and sends the image-processed image data and the information on the print size, the number of prints and so on to the digital mini-laboratory apparatus 610.

The digital mini-laboratory apparatus 610 prints the images by performing the scan exposure on the silver salt color paper with the RGB laser based on the image-processed image data. The photo-prints created by the processing station 600 is directly delivered to a home of a user 700 via the parcel delivery service or delivered to the photographer's studio 500 having requested the print creation.

Next, a description will be given as to a management method of the image data on the original images obtained by the digital shooting at the photographer's studio 500.

As shown in FIG. 4, if the digital shooting at the photographer's studio 500 is finished, the image data on the original images for each user is captured into the hard disk drive 526 from the memory card 511 which is the medium of the digital camera 510 via the card interface 530.

The image processing apparatus 520 creates preview images of a smaller image size than the image data on the original images (image data as is in the color filter arrangement of R, G and B of the image-taking element of the digital camera 510 (RAW data)) from this RAW data. The image size of the preview images is vertically long such as 320×480 pixels (a portrait photo is usually vertically long because it is often vertically shot) for instance.

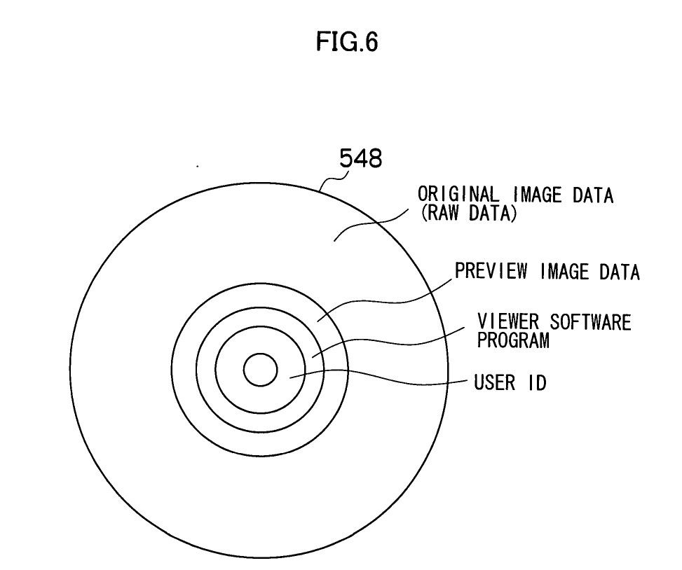

Next, the RAW data of each user stored in the hard disk drive 526 and the image data on the preview images created from the RAW data are recorded on a CD-R 548 (refer to FIG. 6) by the CD-R/RW drive 528.

On this recording, a scramble key is generated for each user by the scramble/descramble portion 542, and the RAW data is scrambled by using the scramble key to be recorded on the CD-R 548. The preview images are recorded on the CD-R 548 in a JPEG (Joint Photographic Experts Group) format without scrambling. Furthermore, as shown in FIG. 6, the CD-R 548 has a viewer software program for viewing the preview images recorded on the CD-R 548 on the monitor of a general-purpose personal computer and the identification data on the user (user ID) recorded thereon.

The CD-R 548 thus created is handed to the user 700 for free (included in a basic shooting fee of the photographer's studio 500).

The user ID to be recorded on the CD-R 548 can be obtained from the information management apparatus 550 via the communication interface 544, and the information on the scramble key used to scramble the RAW data is sent to the information management apparatus 550 via the communication interface 544.

Next, the information management apparatus 550 will be described.

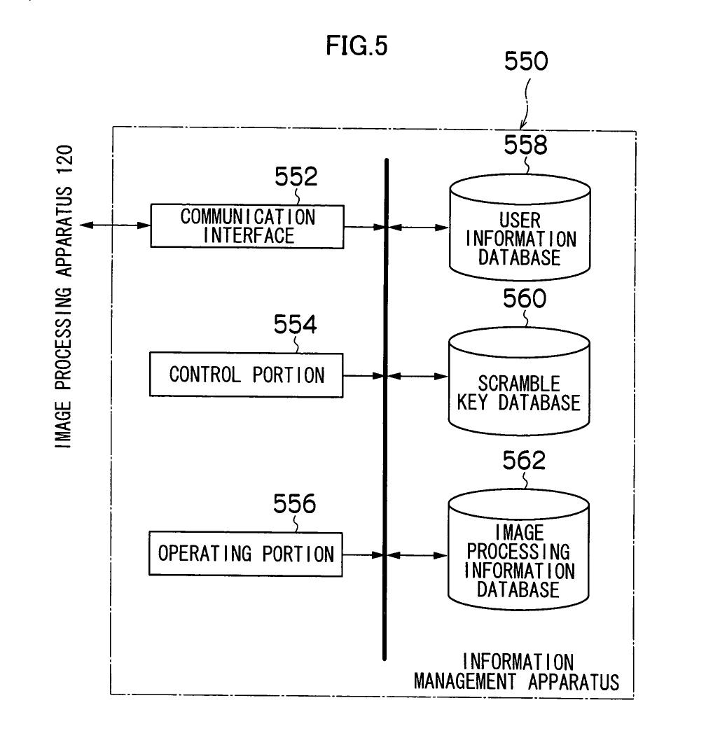

The information management apparatus 550 manages user information, the scramble key and image processing information, and as shown in FIG. 5, it is mainly comprised of a communication interface 552, a control portion 554, an operating portion 556 of the keyboard, mouse and so on, a user information database 558 for managing the user information such as the user ID, address and name (appellation), a scramble key database 560 for managing the scramble key for each user, and an image processing information database 562 for managing the information on the image processing (image processing information) for the printing performed to the RAW data on the image processing apparatus 520.

The control portion 554 integrates and controls the portions in the information management apparatus 550, and includes management software and so on. If it takes in the information on the scramble key used to scramble the RAW data of each user from the image processing apparatus 520, it stores the information on the scramble key in the scramble key database 560 by associating it with the user ID. If it takes in the information on the image processing for the printing to be performed to the RAW data from the image processing apparatus 520, it stores the image processing information in the image processing information database 562 by associating it with the user ID and an image file name.

If the control portion 554 accepts the user's request for acquisition of the scramble key from the image processing apparatus 520 via the communication interface 552, it reads the information on a corresponding scramble key from the scramble key database 560 based on the user ID to pass it to the image processing apparatus 520. Likewise, if it accepts the user's request for acquisition of the information on the image processing performed to the RAW data, it reads corresponding image processing information from the image processing information database 562 based on the information on the user ID, shooting date and file name to pass it to the image processing apparatus 520.

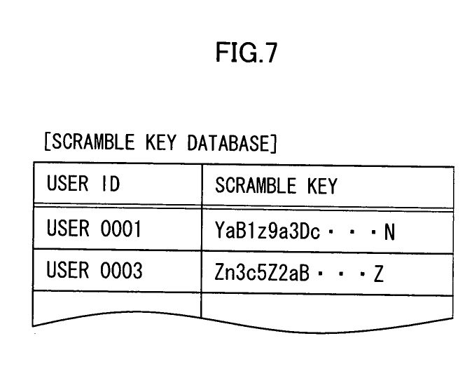

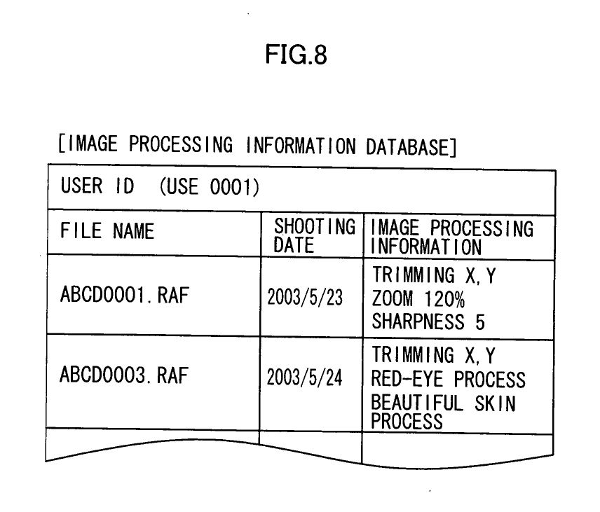

FIGS. 7 and 8 show examples of data structures of the scramble key database 560 and the image processing information database 562 respectively.

Next, a description will be given as to the print order acceptance method of accepting the print order from the CD-R 548 brought to the photographer's studio 500 by the user 700.

The user 700 can take home the CD-R 548 created at the photographer's studio 500 and set it on the personal computer at home so as to view the preview images recorded on the CD-R 548. Thus, the user 700 can carefully select the images for the print order taking time at any desirable time while viewing the preview images recorded on the CD-R 548. The original RAW data on the preview images cannot be opened because it is scrambled.

And in the case of requesting the print order for the images recorded on the CD-R 548, the user 700 brings the CD-R 548 to the photographer's studio 500 to place the print order. The print order may also be placed on the network by sending the user information, file information on the ordered images and so on to the photographer's studio 500 via the network. In this case, however, it is also necessary to bring the CD-R 548 to the photographer's studio 500.

If the print order is placed for the images recorded on the CD-R 548 brought by the user, the photographer's studio 500 sets the CD-R 548 on the CD-R/RW drive 528 (refer to FIG. 4) of the image processing apparatus 520.

First, the image processing apparatus 520 reads the user ID recorded on the CD-R 548 with the CD-R/RW drive 528, and sends the user's request for the scramble key to the information management apparatus 550 together with the user ID. As shown in FIG. 5, on receiving the user's request for acquisition of the scramble key, the information management apparatus 550 reads the information on the corresponding scramble key based on the user ID from the scramble key database 560 and sends it to the image processing apparatus 520.

On obtaining the scramble key from the information management apparatus 550, the scramble/descramble portion 542 of the image processing apparatus 520 uses the scramble key to decode the scrambled RAW data recorded on the CD-R 548 so as to temporarily store the decoded RAW data on the hard disk drive 526.

Thereafter, the operator operates the image processing apparatus 520, and performs the image processing for the proper printing to the print-ordered decoded RAW data. And the operator records the print-ordered RAW data, the information on the image processing performed to the RAW data and the order information on the recording medium, and sends it to the processing station 600.

The information on the image processing performed to the RAW data is sent to the information management apparatus 550 together with the user ID and image file name from the image processing apparatus 520, and is managed in the image processing information database 562 of the information management apparatus 550.

In the case where the image print-ordered with the photographer's studio 500 in the past is print-ordered again, the image processing information as to the RAW data is managed in the image processing information database 562 of the information management apparatus 550. Therefore, the corresponding image processing information is read from the image processing information database 562 to be used. Thus, the burden on the operator performing the image processing for the proper printing is reduced, and the user can obtain the photo-prints of the same finish as those print-ordered and obtained in the past.

According to this embodiment, the presentation for accepting the print-order is incorporated in the work flow of the photographer's studio 500. However, it is possible, by providing the CD-R capable of viewing the images digitally shot at the photographer's studio 500 to the user, to accept the print-order at a later date so as to separate the presentation from the work flow of the photographer's studio 500.

The image processing apparatus 520 and the information management apparatus 550 are separately provided. However, it is possible to either integrate them or share one information management apparatus 550 among a plurality of image processing apparatuses 520.

Furthermore, according to this embodiment, the CD-R is used as the recording medium to be provided to the user. However, it is not limited thereto but may be another removable recording medium such as a DVD. In addition, the RAW data is used as original image data. However, it may also be the data in another format such as JPEG, TIFF (Tagged Image File Format) or BMP (Bit Map). Furthermore, it is not limited to the case of using the scramble key to scramble the original image data so that the user cannot use it, but it is also possible to render the original image data unusable with another key of cryptograph.

According to the present invention, the image data on the original images of each user digitally shot at the photo studio such as the photographer's studio or the shooting studio is encoded by using the key of cryptograph and recorded on the removable recording medium to be provided to the user. Therefore, a large amount of image data on the original images of each user is stored and managed by the user on his or her own so as to reduce the burden on the photo studio of backup of the image data on the original images.

The preview images of a smaller image size than the original images are also recorded on the recording medium. Therefore, the user can view the preview images recorded on the recording medium by using the personal computer and so on, and carefully select the images for the print order taking time at any desirable time.

In the case of a reorder, the photo studio can decode the encoded image data on the original images recorded on the recording medium brought by the user by using the key of cryptograph managed in the database to exploit it. Furthermore, the photo studio performs the image processing such as the trimming, color correction and retouch to the print-ordered original images, and registers the image processing information indicating the contents of this image processing with the database. Thus, it is possible, in the case of accepting the order for extra prints of the photos, to use the image processing information registered with the database and have the same finish of the photo-prints.

It should be understood, however, that there is no intention to limit the invention to the specific forms disclosed, but on the contrary, the invention is to coverall modifications, alternate constructions and equivalents falling within the spirit and scope of the invention as expressed in the appended claims.

What is claimed is:

1. A digital photo print order acceptance method for having digital images digitally shot at a photo studio viewed by a user, printing the digital images for which a print order has been accepted from the user and providing printed images to the user, comprising the steps of:
uploading on a network server unprocessed view images of a smaller image size than original images obtained by the digital shooting from a terminal of the photo studio;
performing image processing for proper printing to the original images at the photo studio;
uploading on the network server image processing information indicating the image processing corresponding to the view images uploaded on the network server as supplementary information to the view information;
performing the image processing to the view images uploaded on the network server based on the image processing information supplementary to the view images, and rendering image-processed view images viewable on the terminal of the user; and
if the print order is placed based on the view images by using the terminal of the user, posting the order information indicating the print order to the terminal of the photo studio.

2. The digital photo print order acceptance method according to claim 1, wherein the image processing information supplementary to the view images uploaded on the network server is utilized for calculation of a usage fee of an image processing device which performs the image processing for properly printing the original images conducted at the photo studio.

3. The digital photo print order acceptance method according to claim 1, wherein the photo studio sends the original images corresponding to the order information, the image processing information and the order information to a processing station via a network or a recording medium.

4. The digital photo print order acceptance method according to claim 3, wherein the image processing information sent to the processing station based on the image processing information supplementary to the view images uploaded on the network server and the order information from the terminal of the user, is detected, and the detected image processing information is utilized for calculation of the usage fee of the image processing device which performs the image processing for the proper printing to the original images used by the processing station.

5. A digital photo print order acceptance method for having digital images digitally shot at a photo studio viewed by a user, printing only the digital images for which a print order has been accepted from the user and providing printed images to the user, comprising the steps of:
uploading on a network server view images of a smaller image size than original images obtained by the digital shooting and having undergone no image processing for printing from a terminal of the photo studio;
rendering the view images uploaded on the network server viewable on the terminal of the user, and if the user selects images of which print finish check is desired out of the view images, posting information on the selected images to the terminal of the photo studio;
performing the image processing for the proper printing to the original images corresponding to the selected images at the photo studio;
rendering the view images for checking the print finish to which the image processing has been performed viewable to the user via the network server and the terminal of the user; and
if the print order is placed based on the view images for checking the print finish by using the terminal of the user, posting the order information indicating the print order to the terminal of the photo studio.

6. A print order acceptance method, comprising the steps of:
encoding image data on original images obtained by digital shooting at a photo studio by using a cryptographic key and recording encoded image data on a removable recording medium to be provided to a user;
creating preview images of a smaller image size than the original images from the original images and recording the image data on the preview images on the recording medium;
associating identification data on the user possessing the recording medium with the cryptographic key used to encode the original images on the recording medium and managing associated data in a database;
accepting the print order for desired original images recorded on the recording medium from the user possessing the recording medium;
taking the cryptographic key used to encode the image data on the original images on the recording medium from the database based on the identification data on the user possessing the recording medium; and
decoding the image data on the print-ordered original images recorded on the recording medium by using the cryptographic key taken out.

7. The print order acceptance method according to claim 6, further comprising the steps of: performing the image processing for proper printing to the image data on the print-ordered original images; and registering image processing information indicating the contents of the image processing with the database by associating the image processing information with the identification data on the user and a file name of the original images.

8. The print order acceptance method according to claim 7, further comprising the step of: sending the processing station the image data on the original images, the image processing information indicating the contents of the image processing for the image data on the original images, and the order information indicating the contents of the print order.

9. A digital image management method, comprising the steps of:
encoding image data on original images obtained by digital shooting at a photo studio by using a cryptographic key and recording the encoded image data on a removable recording medium to be provided to a user;
creating preview images of a smaller image size than the original images from the original images and recording the image data on the preview images on the recording medium; and
associating identification data on the user possessing the recording medium with the cryptographic key used to encode the original images on the recording medium and managing associated data in a database.

10. The digital image management method according to claim 9, further comprising the step of: recording the identification data on the user possessing the recording medium on the recording medium.

11. The digital image management method according to claim 9, further comprising the step of: recording on the recording medium a viewer software program for viewing the preview images recorded on the recording medium.

12. The digital image management method according to claim 9, wherein the recording medium is a CD, a DVD or a memory card.
